(19) United States
(12) Patent Application Publication
(10) Pub. No.: US 2015/0058026 A1
(43) Pub. Date: Feb. 26, 2015

(54) SECONDARY CARETAKER NOTIFICATION METHOD AND SYSTEM

(71) Applicant: No Pet Left Behind LLC, Bentonville, AR (US)

(72) Inventor: Susan Lee Hoeller, Land 'O Lakes, FL (US)

(73) Assignee: No Pet Left Behind LLC, Bentonville, AR (US)

(21) Appl. No.: 13/972,071

(22) Filed: Aug. 21, 2013

(51) Int. Cl. G06F 19/00

(52) U.S. Cl. CPC G06F 19/327
USPC 705/2

(57) ABSTRACT

Method and computer system is disclosed for notifying a secondary caretaker of the inability of a primary caretaker to tend to the health or welfare of a designated pet or person. A caretaker database table has fields for receiving primary caretaker identification data, secondary caretaker identification data and designated pet or person identification data. A check-in time is set by a user, the check-in time being received in a time set module correlated to a specific record in the caretaker database table. If the primary caretaker check-in value is true, a reset of the time set module is prompted to reset a new check-in time or terminate the computer program. While the check-in value is false the check-in time is compared to the actual time, and when the actual time is the same or later than the check-in time, a message is sent to the secondary caretaker.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

It is not uncommon for a domesticated pet, such as a dog or cat, to be left in a home or other regular location alone during a certain time period when the pet owner, being the primary caretaker, is absent from the home or other location, such as when the pet owner is at work or on a short business trip. For purposes of this invention, pet owner refers to any person who is the primary caretaker of the pet. For the pet owner there is often associated with the absence, an amount of concern that if the pet owner is unable to return to the home or other location at a usual prescribed time, or is otherwise unexpectedly kept away from the pet, such as if the pet owner is in an accident, there will be no-one to see to the care and welfare of the pet. There exists conventional means for a primary caretaker to be able to call or notify a friend or relative, for example, a secondary caretaker, to go to the location of the pet, if the primary caretaker is unable to get to the location at an appropriate time. But this conventional means requires the primary caretaker to be able to affirmatively notify the secondary caretaker.

It would be advantageous to have a method and system for providing a notification to a secondary caretaker to attend to the health and welfare of a pet in the event that the primary caretaker is unable to do so. The invention provides such a method and system. The invention is also applicable to the context of the attending to the health and welfare needs of a person, such as an elderly, sick, infirm or young person.

### BRIEF SUMMARY

The present invention relates to a notification method and system used to notify or alert a secondary caretaker in the event of the inability of the primary caretaker to attend to the health and welfare needs of a pet or person at or after a prescribed time. As used herein, the term system refers to the combination of hardware and software necessary to implement the claimed functionality as further described herein.

### BRIEF DESCRIPTION OF THE FIGURES

In the following section, the invention will be described with reference to exemplary embodiments illustrated in the figures, in which:

FIG. 1 is a flow chart of the steps of the invention;

FIG. 2 is a block diagram of a computer operable to perform the steps of the invention;

FIG. 3 is a block diagram of a networked computer system operable to perform the steps of the invention;

FIG. 4 is a block diagram of a network operable to perform the steps of the invention; and

FIGS. 5-13 are illustrative graphical user output from the steps of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

As used herein, a network element (e.g., a router, switch, bridge) is a piece of networking equipment, including hardware and software that communicatively interconnects other equipment on the network (e.g., other network elements, end stations). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video). End stations (e.g., servers, workstations, laptops, netbooks, palm tops, mobile phones, smartphones, multimedia phones, Voice Over Internet Protocol (VOIP) phones, user equipment, terminals, portable media players, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

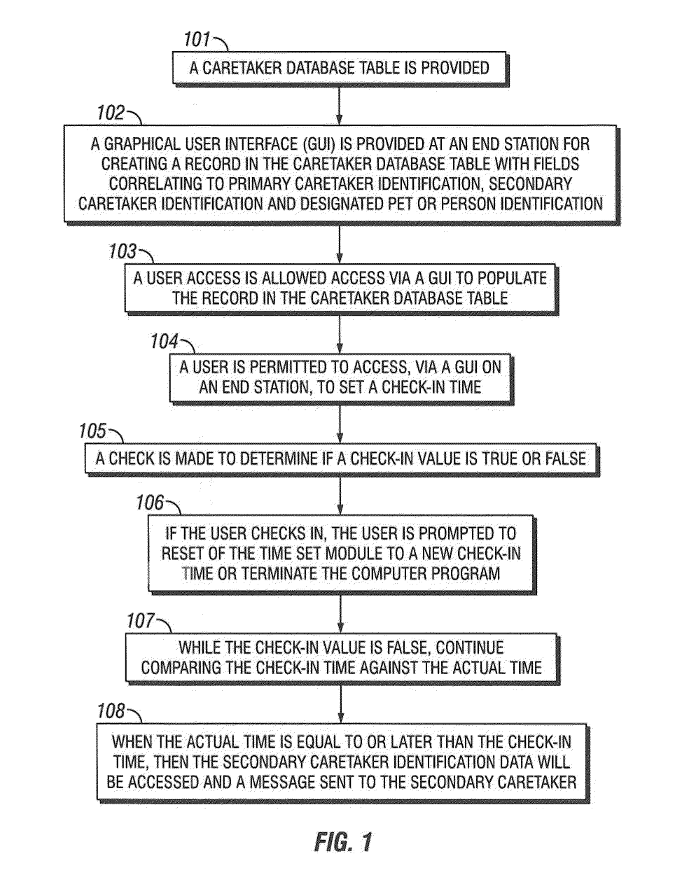

FIG. 1 is a flow chart of a method 100 of the invention. As seen therein, the invention is a method performed by a computer system including and end station and having at least one microprocessor comprised of electronic circuitry directed by a computer program comprising instructions embodied on a non-transitory computer readable medium and at least one memory comprising a non-transitory computer readable medium, for notifying a secondary caretaker of the inability of a primary caretaker to tend to the health or welfare of a designated pet or person.

In step 101, a caretaker database table is provided.

In step 102 a graphical user interface (GUI) is provided at an end station for creating a record in the caretaker database table with fields correlating to primary caretaker identification, secondary caretaker identification and designated pet or person identification.

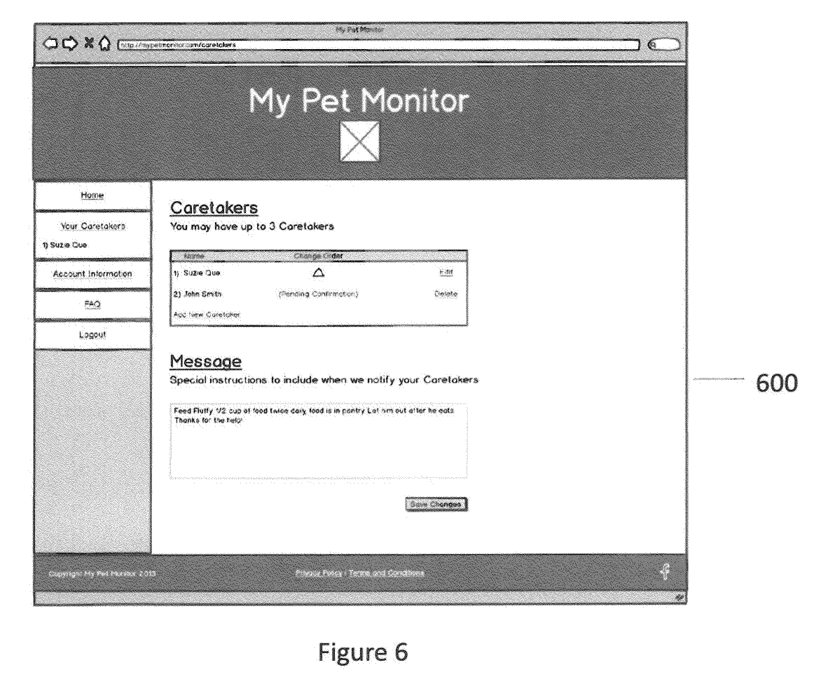

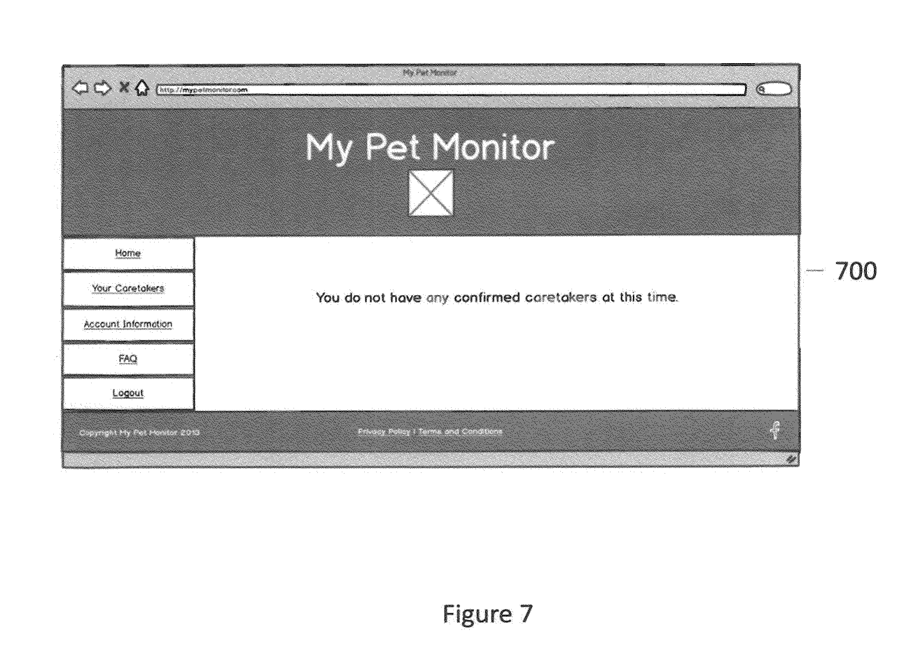

In step 103, a user access is allowed access via a GUI to populate the record in the caretaker database table with primary caretaker identification data, secondary caretaker identification data and designated pet or person identification data. GUI form 600 of FIG. 6 provides a GUI which can be displayed and allow the user to select the secondary caretaker to receive a notification and the message of such notification. GUI form 700 of FIG. 7 provides illustrates a GUI that can be displayed if a secondary caretaker has not been selected.

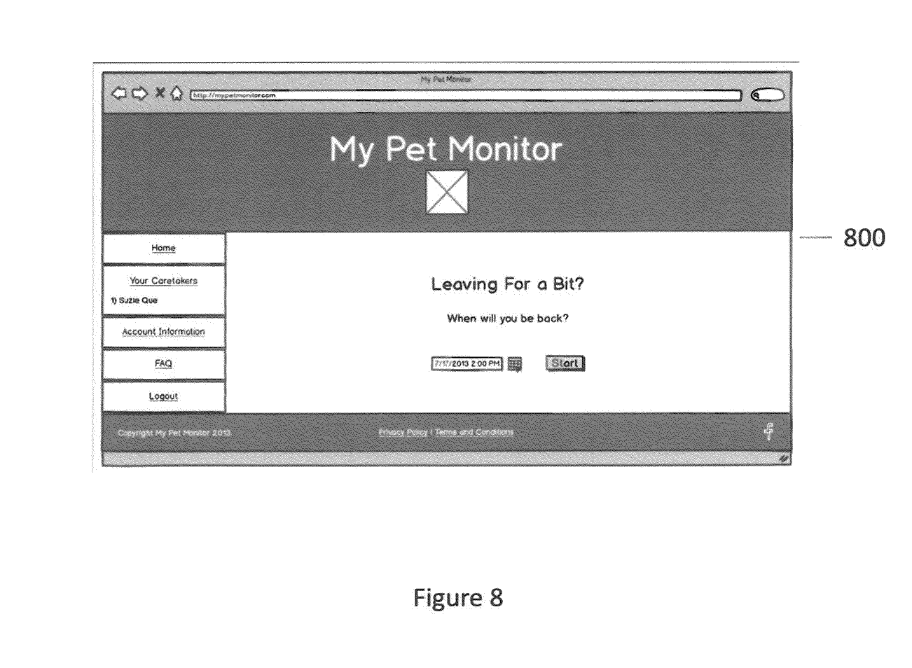

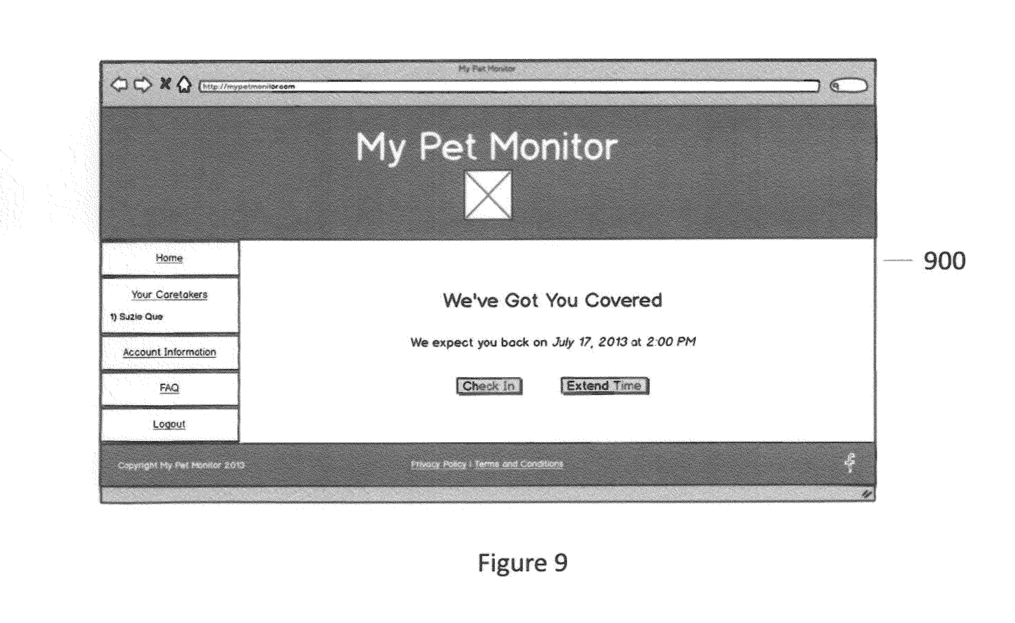

In step 104, a user is permitted to access, via a GUI on an end station, to set a check-in time in a time set module correlated to a specific record in the caretaker database table. GUI form 800 of FIG. 8 illustrates a GUI which can be displayed and which allows the user to set a check-in time. GUI form 900 of FIG. 9 illustrates a GUI which can be displayed once a user has selected a check-in time with buttons to allow the user to check in or extend time.

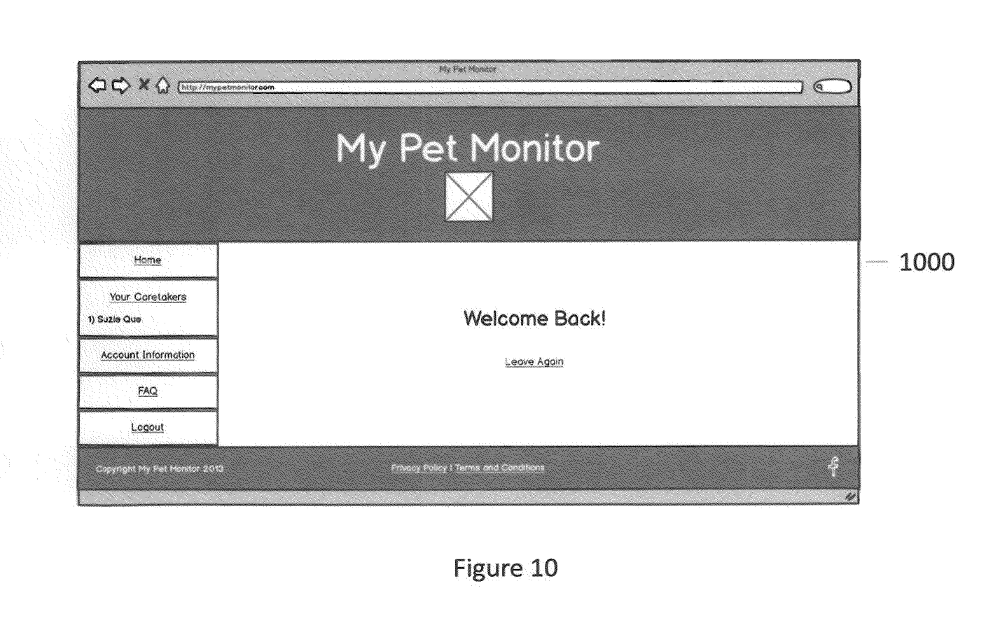

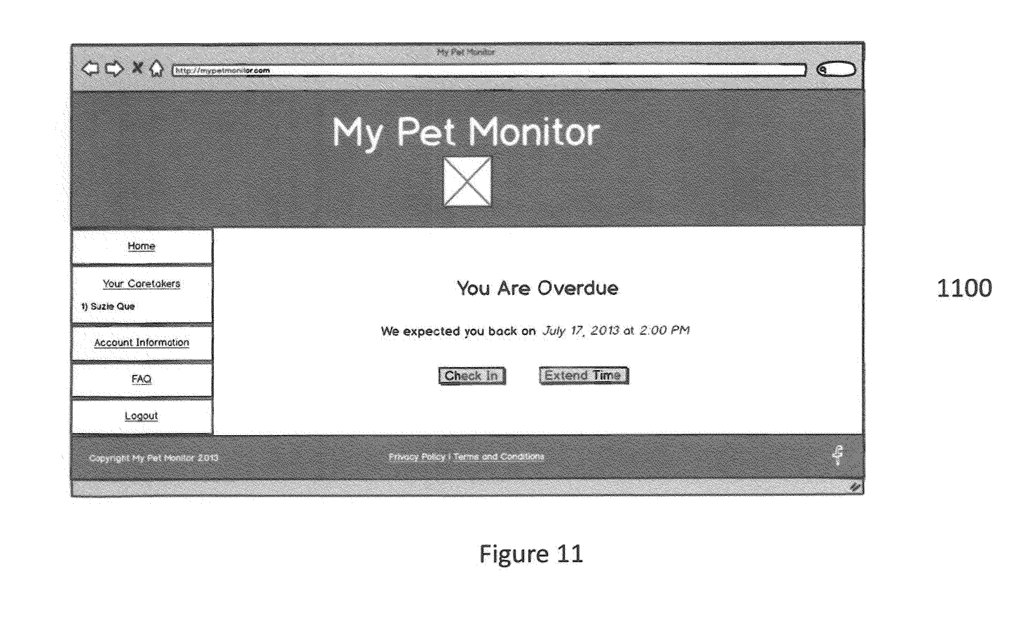

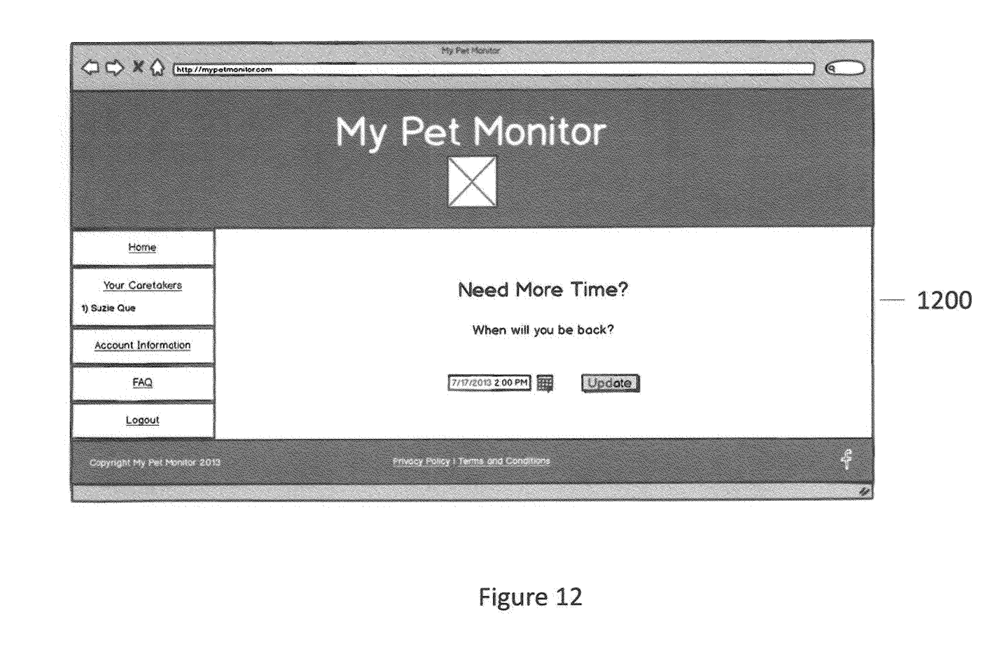

In step 105, a check is made to determine if a check-in value is true or false. The default value when the computer program is running is false. The user is allowed access, via a GUI on an end station, to, in effect, set a primary caretaker check-in value to true. This relates to when a user, typically the primary caretaker, arrives at home or his/her location and accesses the computer program prior to the check-in time so as to keep a message from being sent to the secondary caretaker. Upon such access, the user can be displayed a GUI similar to GUI 1000 of FIG. 10. As noted below, if the primary caretaker does not check-in via the end station GUI, then a value or flag in the computer program remains false, allowing, in a later step, for a message to be sent to a secondary caretaker if the actual time and the check-in time are equal, or the check-in time has arrived without the check-in value being set by the user to true via the end station GUI. If the primary caretaker does not check-in via the end station GUI, GUI form similar to GUI form 1100 as seen in FIG. 11 can be displayed. A further GUI form, such as GUI form 1200 as seen in FIG. 12 can be displayed.

In step 106, if the primary caretaker checks in via the end station GUI, thus causing the check-in value to be true, the user is prompted to reset of the time set module to a new check-in time or terminate the computer program and is displayed a GUI form similar to GUI form 1000 of FIG. 10.

In step 107, while the check-in value is false, a microprocessor, at the end station or at a server, will continue comparing the check-in time against the actual time. In step 108, when the actual time is equal to or later than the check-in time, then the secondary caretaker identification data will be accessed and a message sent to the secondary caretaker. In addition, the GUI form 1100 of FIG. 11 can be displayed. As previously noted, a further GUI form, such as GUI form 1200 as seen in FIG. 12 can be displayed.

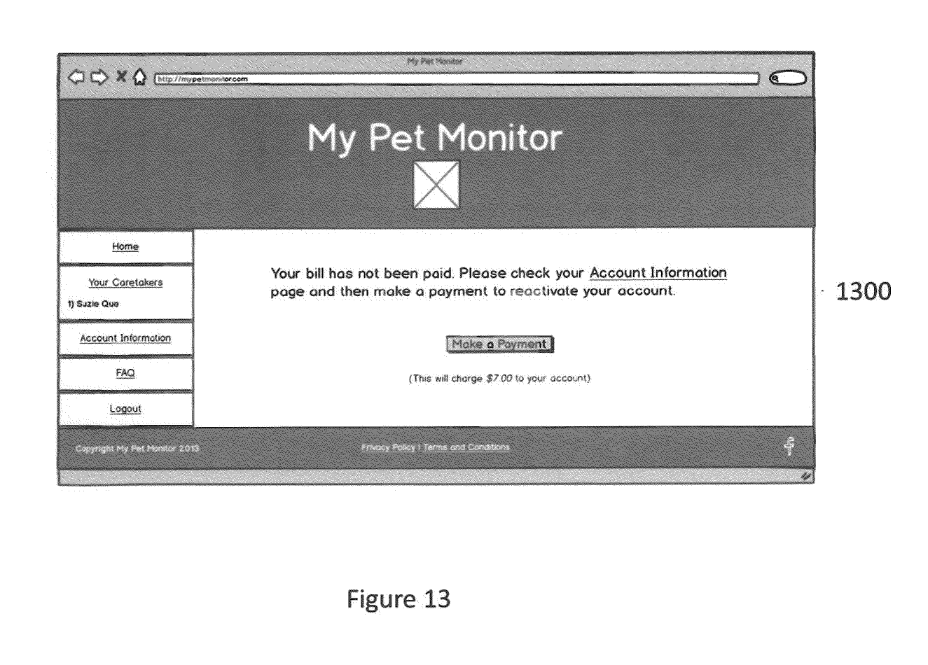

If a user or primary caretaker fails to pay the service that implements the invention, a GUI form similar to GUI form 1300 as seen in FIG. 13 can be displayed.

Note that the computer program of the invention preferably comprises a client component local to a user at an end station and a server component on a server end station remote to the user, the client component configured to access the server component over a computer network via a plurality of network elements or nodes.

The communication of the client component with the server component can occur over wired channel, a wireless channel or a combination thereof, using physical, data, link and transport layer protocols.

A user creates a specific caretaker database record which is populated with primary caretaker identification data. The primary caretaker identification data preferably comprises the first and last name of the user, typically, the primary caretaker, username and password, address, email address, and, based on billing information received from the primary caretaker, billing information correlated to banking information of the primary caretaker from which automated payments can be made for access to the service facilitated by the invention, on a predetermined basis. In this manner, a user can be allowed to access the computer program via an end station, but hosted by a third party on a remote server. Following an authentication and authorization process, the primary caretaker or his/her designee can direct funds to be sent to the third party using an electronic funds transfer mechanism on a predetermined basis. The third party can be a company or person that is hosting, or having hosted, the computer program on a server or as a cloud-based service on a remote network element. The primary caretaker or user can sign in initially as a visitor and enter in primary caretaker identification data to join the service facilitated by the invention or can try the service on trial basis. If a primary caretaker signs in on a trial basis and does not unsubscribe from the service facilitated by the invention within a predetermined amount of time, then the primary caretaker will be deemed to be a regular user of the service with automated monthly payments being made based on the billing information.

The designated pet or person identification data preferably comprises the location of the designated pet or person. In this way, if a message is sent to the secondary caretaker, the secondary caretaker knows where to go to attend to the health and welfare of the designated pet or person. The designated pet or person identification data can also further comprise a name and care instructions of the designated pet or person. In this way, a pet can be let out of the house or fed, for example, or a child taken to a safe location.

The secondary caretaker identification data can further comprise an identifier at which the message can be sent to the secondary caretaker. The identifier can consists of any of an address, a telephone number, an e-mail address, a media access control (MAC) address, or an Internet Protocol (IP) address, or a combination of the foregoing. Further, the message itself can consist of any of a letter, a text message, an automated telephone call, an Internet Message (IM) chat message, a VoIP call and an e-mail. According to an embodiment of the invention, there can be a plurality of secondary caretakers, each having their own secondary caretaker identification data.

The message is then operative to notify or alert the secondary caretaker, based on an abstraction that the primary caretaker check-in value is false, that the secondary caretaker should check on the health or welfare of the designated pet or person at the location specified in the designated pet or person data.

The GUI is preferably an intuitive screen displayed on a computer monitor at the end station and is responsively coupled to a computer input device, such as a keyboard and mouse, so as to accept data into the caretaker database table of the computer program and to display output. In an embodiment, the computer program is written in the Python programming language, but as one skilled in the art would recognize, any suitable specialized or general purpose computer programming language can be used to create the computer program. The GUIs can comprise a single integrated GUI or a plurality of screens each arranged to prompt the input of data into the computer program. Alternatively, data can be entered into the computer program using a command line interface.

In the invention, the user is prompted to enter a check-in time being the time that the user, typically the primary caretaker, needs to access the computer program to keep it from sending a health and welfare message to a secondary caretaker. The check-in time preferably is a date, comprising a month, day and year, and time, comprising at least hour and minutes and either p.m. or a.m., and a time zone identification. If the primary caretaker does not access via an end station, the computer program prior to that check-in time, a message is sent to the secondary caretaker. If the user, typically the primary caretaker or his/her designee, does check in prior to the check-in time, the invention prompts the user to enter a later time as a new check-in time, and the computer program is reset to perform the functions of the invention again based on the new check-in time, or the user can terminate the computer program, until it is required at a later time.

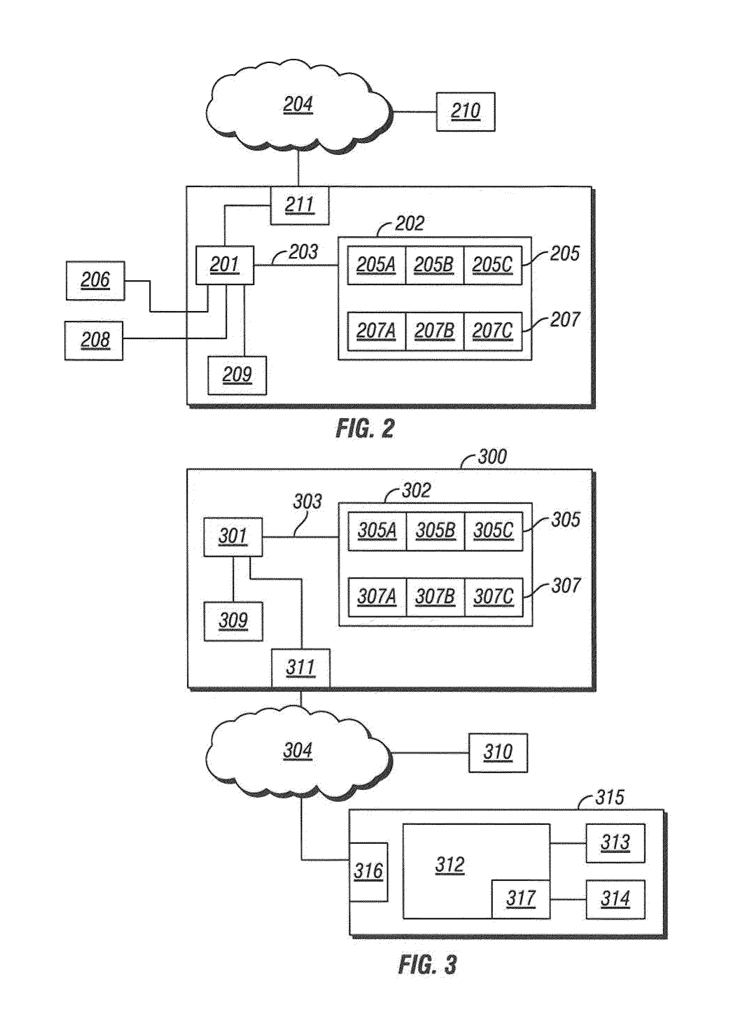

As seen in FIG. 2, the method of the invention is performed by an end station being a networked computer 200 having at least one microprocessor 201 comprised of electronic circuitry directed by a computer program comprising instructions embodied on a non-transitory computer readable medium and at least one memory 202 comprising a non-transitory computer readable medium, said memory 202 coupled to the microprocessor 201 via bus 203 and configured to notify, using a communication interface 211, a secondary caretaker 210 via a network connection 204 of the inability of a primary caretaker to tend to the health or welfare of a designated pet or person.

In memory 202, a caretaker database table 205 is configured with fields correlating to primary caretaker identification 205A, secondary caretaker identification 205B and designated pet or person identification 205C.

An input device 206 is operable to allow a user to populate the caretaker database table 205 with a specific caretaker database record 207, using a GUI displayed on an output device 208, such as a computer monitor. Primary caretaker identification data 207A, secondary caretaker identification data 207B and designated pet or person identification data 207C is inputted into each specific caretaker record by the user, typically the primary caretaker.

A time set module 209 is configured to receive a check-in time correlated to a specific caretaker database record 207.

The microprocessor 201 is further configured to check if a primary caretaker check-in value is true or false. If the primary caretaker check-in value is true, the microprocessor 201 is configured to prompt a reset of the time set module to a new check-in time or terminate the computer program as previously noted herein.

While the primary caretaker check-in value is false, the microprocessor 201 is configured to continue to compare the check-in time against the actual time.

When the actual time is later than the check-in time, the microprocessor 201 is configured to access the secondary caretaker identification data 207B from the associated record 207 from the caretaker database table 205 and cause a message to be sent to the secondary caretaker.

As seen in FIG. 3, a further embodiment of the method of the invention is performed by a combination of a server 300 and a client 315, the server 300 being a networked computer 300 having at least one microprocessor 301 comprised of electronic circuitry directed by a computer program comprising instructions embodied on a non-transitory computer readable medium and at least one memory 302 comprising a non-transitory computer readable medium, said memory 302 coupled to the microprocessor 301 via bus 303 and configured to notify a secondary caretaker 310 via a network connection 304 of the inability of a primary caretaker to tend to the health or welfare of a designated pet or person.

In memory 302, a caretaker database table 305 is configured with fields correlating to primary caretaker identification 305A, secondary caretaker identification 305B and designated pet or person identification 305C.

Client 315 comprises a networked computer having at least one microprocessor 312 comprised of electronic circuitry directed by a computer program comprising instructions embodied on a non-transitory computer readable medium and at least one memory 317 comprising a non-transitory computer readable medium, said memory 317 coupled to the microprocessor 312 via a bus.

An input device 313 is operable to allow a user to populate the caretaker database table 305 over the network with a specific caretaker database record 307, using a GUI displayed on an output device 314, such as a computer monitor. Primary caretaker identification data 307A, secondary caretaker identification data 307B and designated pet or person identification data 307C is inputted into each specific caretaker record by the user, typically the primary caretaker.

Referring back to the server 300, a time set module 309 is configured to receive a check-in time correlated to a specific caretaker database record 307.

The microprocessor 301 is further configured to check if a primary caretaker check-in value is true or false. If the primary caretaker check-in value is true, the microprocessor 301 is configured to prompt a reset of the time set module to a new check-in time or terminate the computer program as previously noted herein.

While the primary caretaker check-in value is false, the microprocessor 301 is configured to continue to compare the check-in time against the actual time.

When the actual time is later than the check-in time, the microprocessor 301 is configured to access the secondary caretaker identification data 307B from the associated record 307 from the caretaker database table 305 and cause a message to be sent to the secondary caretaker 310 via the network 304.

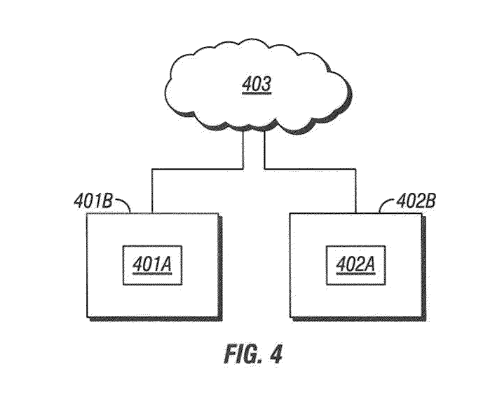

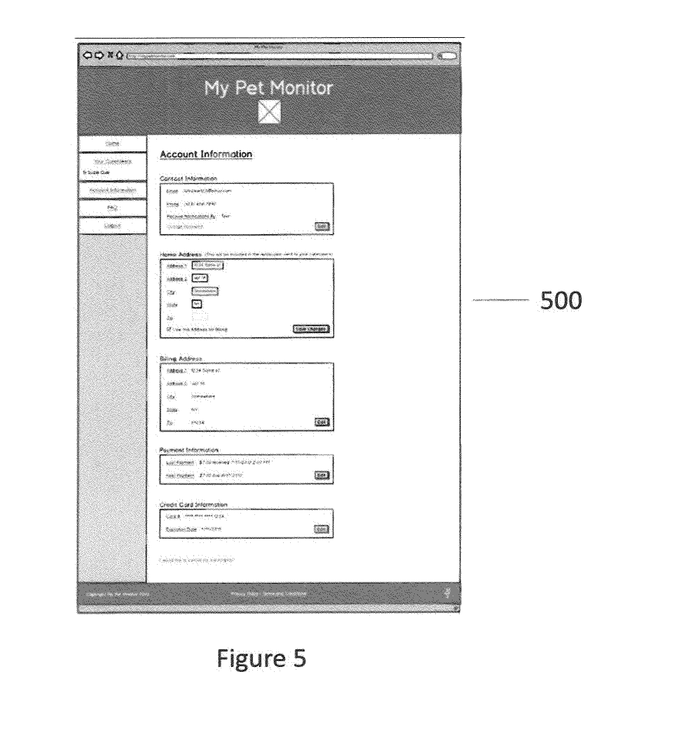

As seen in FIG. 4, the computer program can comprise a client component 401A on a computer end station 401B local to a user and a server component 402A on a server end station 402B remote to the user, the client component 401A accessing the server component 402B coupled over a computer network 403 having a plurality of network elements.

A computer network is a geographically distributed collection of interconnected communication links and sub-networks for transporting data between nodes, such as computers. Many types of computer networks are available, with the types ranging from local area networks (LANs) to wide area networks (WANs). A LAN is an example of a sub-network that provides relatively short distance communication among the interconnected stations, whereas a wide area network enables long distance communication over a larger geographic area using links provided by public or private telecommunications facilities. The nodes typically communicate by exchanging discrete frames or packets of data according to predefined protocols. In this context, a protocol consists of a set of rules defining how the nodes interact with each other.

Computer networks may be further interconnected by an intermediate node, called a router, to extend the effective “size” of each network. Since management of a large system of interconnected computer networks can prove burdensome, smaller groups of computer networks may be maintained as routing domains or autonomous systems. The networks within an autonomous system are typically coupled together by conventional intra-domain routers. These routers manage communication among local networks within their domains and communicate with each other using an intra-domain routing (or an interior gateway) protocol.

The client component 301A communicates with the server component 302B over wired channel, a wireless channel or a combination thereof using physical, data, link and transport layer protocols. The client component 301A and server component 302B communicate using a variety of messages between the components, including an initial handshake or initialization messages, authentication messages and data transfer and control messages. Such data and/or control messages are preferably encrypted or hashed to prevent an undesired third party from spoofing the sender or otherwise tamper with or redirect the message. In order to verify that the client component 301A is the entity or object it purports to be, reference may be made by the server component 3016 to a separate authentication server, such as a RADIUS server. Alternatively, the client component 301A may first require authentication from an authentication server as part of setting up the communication with the server component 301B.

As previously noted, the primary caretaker identification data comprises the name of the primary caretaker and billing information of the primary caretaker, the billing information being correlated to banking information of the primary caretaker. The designated pet or person identification data comprises the location of the designated pet or person and care instructions of the designated pet or person. The secondary caretaker identification data comprises an identifier at which the message can be sent to the secondary caretaker. The identifier consists of one selected from the group consisting of a telephone number, e-mail address, media access control (MAC) address, and Internet Protocol (IP) address and the message comprises one selected from the group consisting of a text message, automated telephone call, Internet Message (IM) chat message, VoIP call and email.

A further specific embodiment of the invention is hereinafter provided. A GUI is provided when a user first visits a visitor home page of a website offering the service implemented by the invention. The visitor home page includes content describing the service provided by the application, as well as a link/button prompting the visitor to sign up and begin a free trial. Clicking the link/button will take the visitor to the same user creation form as the create_account link/button on the Login page. If the trial user does not unsubscribe from the service before the completion of the trial period, they will be enrolled in automatic monthly payments and become a paid user. When a visitor initiates the process of setting up an account, they will be presented with a step-by-step GUI form so that they can provide, inter alia, their first and last name, email and password, home and billing addresses, and credit card data. The form can also require the user to assent to a terms_and_conditions. Upon submission of the form, the user is taken to the login_page. The user will receive an email when their account is first charged verifying that their account has been charged and stating that payments will be made on the same day of each month thereafter.

In the login_page, a call or request is made to a server or component to authenticate a user's credentials such as email and password. The login_page also provides links for the creation of a new account and password retrieval. If a visitor clicks the create_account link, they are taken to the same step-by-step GUI form found under the signup_page. If a user activates the forgot_password link, a GUI is provided where the user is asked to input their email address. When the user submits their email address they will receive an email with a link to change their password. Upon successful login, a user is taken to a home_page associated with the service implemented by the invention.

The home_page has multiple functions that can be displayed alternatingly. A set_time function allows a logged in user to choose and submit future date-time data. Upon submission, user is taken to the check_in function. The check_in function displays the date-time data selected by the user in the previous step and provides buttons to facilitate a check_in function or extend_time function. The check in function terminates the timer and accesses the welcome_back function. The extend_time function takes a user to the extend time GUI section. The welcome_back function displays a welcome back GUI message and provides a link to the set_time function. An overdue function displays a GUI message stating the time the user was expected to check in and GUI buttons for the user to activate the check_in function or extend_time function. The check_in function activates the welcome_back function, while the extend_time function takes the user to the extend time GUI. The extend_time function provides the user a way to enter future date-time data (similar to the set_time function). Upon submission of date-time data, the user's currently active timer is overwritten with the newly submitted date-time data and the user is taken back to the GUI for accessing the check_in function, the GUI associated therewith having been updated to display the new date-time data. A no_caretakers section displays a GUI message if the user does not yet have any confirmed caretakers.

The make_payment function displays a GUI message if the user has not paid an associated bill or invoice and provides a GUI link for the user to go to a GUI associated with the account_information function. This GUI also is associated with a make_payment function for the user to pay a bill, and a GUI message stating that activating a link or button on the GUI will cause the computer program to perform steps to charge the user's account a certain amount.

A caretakers GUI will display a list of user's secondary caretakers. The rows of the list are numbered up to a predetermined maximum (e.g., three). Each caretaker row in the GUI list can include data for a secondary caretaker's first and last name. An up arrow icon on the GUI can be clicked to move that secondary caretaker row up one spot. In this way the user may change the order in which their secondary caretakers are notified. An edit link/button allows editing the name and email address data of the secondary caretaker, and contains a link/button for deleting the secondary caretaker. Changing the email address data will result in a caretaker_update email being sent to the new email address. Deleting a secondary caretaker will remove that secondary caretaker from the secondary_caretakers data and list as well as email and phone records, and send the secondary caretaker an email informing them that they are no longer listed as a secondary caretaker for that user. If the secondary caretaker has not confirmed their participation in the service implemented by the invention, the secondary caretaker list entry will show the secondary caretaker's name and will denote it as pending confirmation. Alternatively, if the secondary caretaker has declined to participate in the service, a message will be sent indicating enrollment denied. In both of these cases, an icon which is normally associated with a edit related link/button will instead be a delete link/button.

If a user has fewer than three (or whatever the maximum number allowed is) secondary caretakers, the final row in the GUI list will have a link/button to add new secondary caretaker data. Clicking the link/button will bring up a GUI form for caretaker name and email address data, and a submit button that is operative to send the entered data to the database or server that is hosting the service implemented by the invention. In an embodiment, two secondary caretakers under the same user may have identical names, but not identical email addresses. An individual who was previously a secondary caretaker for the user and was deleted by the user may be reinstated. When this data is submitted, a caretaker_enrollment email is sent. Moving a secondary caretaker up/down the GUI list can be saved asynchronously. In addition to the secondary caretaker list, a GUI associated with a your_caretakers function also has an editable multiline text area for the user to update the notification message which will be sent to secondary caretakers in the instructions email. A GUI save button will be paired with the text area.

A further GUI is associated with an account_information function. There are several sub-GUIs and sub-functions associated with this function, including contact_information, home_address, billing_address, payment_information, credit_card_information, and a function allowing a user to cancel their subscription to the service implemented by the invention. Each GUI associated with one of the foregoing functions includes an edit function that transforms GUI labels into editable fields so that the user can edit the information. The edit GUI changes to a save changes GUI which is operative to commit the changes, if any. The GUI associated with the contact_information function displays data related to phone number, email address, choice of voice or text notifications, and a change password GUI link. Clicking the change password GUI link will bring up an overlay window GUI for the user to input data related to their current password, new password, and confirm new password, including save and cancel GUI buttons. The GUI associated with the home address data displays address, city, state, and zip code. There is also a checkbox for users to indicate if a billing address is the same as home address. If the box is checked a billing_address function will autofill the GUI with saved home address information. The billing address GUI displays address, city, state, and zip code data. The payment Information GUI displays last payment, and next payment data. The credit card GUI displays data related to a card number (e.g., only last four digits shown) and expiration date. The GUI associated with the cancel subscription link/button redirects the user to an are_you_sure function with GUI buttons for confirm and cancel. Submitting a confirm data via the GUI link inactivates the associated account and deletes the credit card data and a GUI screen is displayed notifying the user. Submitting cancel data redirects the user back to the GUI associated with the account Information function.

An administrator function is associated with an administrator GUI and allows and administrator see a display of the number of trial and paid users and create an affiliate. In this manner, an administrator of the service implemented by the invention can provide data related to the name of the affiliate and create a promotional code. In this manner, the system hosting the service will generate a link that can be distributed to the affiliate. The administrator GUI can further display total earned by each affiliate and generate a report that can displayed on a GUI showing which users have been overdue for a predetermined number of hours without a response from them or their secondary caretakers. Each entry in this GUI will show the user's name, phone number, and the date and time at which they were due home.

The invention further provides an overdue functionality. If a user does not cancel a check-in timer before it expires, the invention, using the check-in timer, will wait fifteen minutes. If the user hasn't checked in after fifteen minutes the invention will transmit or send the user a voice/text and/or e-mail notification. If the user has not checked in within thirty minutes, the invention will send the user another voice/text and/or e-mail message prompting them to check in. If, one hour later, if the user has still not checked in, they will receive another voice/text and/or e-mail notification by the system implementing the invention. If they have not checked in within fifteen minutes they will receive another voice/text and/or e-mail message by the system implementing the invention prompting them to check in. If the user has not checked in within thirty minutes of the second round of notifications the first secondary caretaker will receive a voice/text and/or e-mail message informing them that the user (primary caretaker) has not checked in and asking them if they will take responsibility for checking on the user's designated person or pets. In the case of a text message they will be prompted to reply “Yes”. The system implementing the invention will accept replies regardless of casing and allow for “yes” or “yse” spellings. If the system implementing the invention receives an invalid reply it will send another text message informing the secondary caretaker that the system could not understand the reply and request them to resubmit the data. If the secondary caretaker replies “no”, the system implementing the invention will move on to the next secondary caretaker. In compliance with text messaging laws, if the secondary caretaker replies “stop”, the system implementing the invention will no longer send such secondary caretaker messages. In this instance the secondary caretaker will be removed from the system implementing the invention as if they had been deleted and the user's caretaker list will be updated to show the enrollment denied message. In the case of a voice message the secondary caretaker will be prompted to press a key (e.g., five) for yes. If the secondary caretaker has not responded within one hour they will receive another voice/text and/or e-mail message. After thirty minutes, if the user and the first secondary caretaker have not responded, the system implementing the invention will move on to the next secondary caretaker if there is one. The next secondary caretaker will receive a voice/text message and/or e-mail identical to the one sent to the first secondary caretaker, and another such message an hour later if there is no response. The system implementing the invention will repeat the previous step if there is a third secondary caretaker, and so on. If no one has responded one hour after the final secondary caretaker was last contacted, the system implementing the invention will send the first secondary caretaker a more urgently worded voice/text and/or e-mail message. Each secondary caretaker will receive an identical message thirty minutes after each other if no one responds. If no one has responded twenty-four hours after the user was expected to check in, the system will add the user to the report generated by the administrator_function. If at any point a secondary caretaker responds that they accept the responsibility of checking on the user's designated person or pet, they will receive a voice/text and/or email with detailed instructions, including the custom message created by the user pursuant to the account_information function. The responding secondary caretaker will also receive a voice/text and/or e-mail message thanking them and prompting them to check their voice/text and/or email for instructions. At that time the user (primary caretaker) and the other secondary caretakers who have been contacted will also receive voice/text and/or text messages from the system implementing the invention. The message sent to the user will inform them which secondary caretaker has accepted the responsibility, while the other secondary caretakers' messages will simply inform them that the responsibility has been taken and there help or services are not needed at that time.

Example Time Flow (3 secondary caretakers, no response)

00:00—User is overdue

00:15—Voice/Text and/or e-mail notification to user

00:30—Voice/Text and/or e-mail to user

01:15—Voice/Text and/or e-mail to user

01:30—Voice/Text and/or e-mail to user

02:00—Voice/Text and/or e-mail to secondary caretaker 1

03:00—Voice/Text and/or e-mail to secondary caretaker 1

03:30—Voice/Text and/or e-mail to secondary caretaker 2

04:30—Voice/Text and/or e-mail to secondary caretaker 2

05:00—Voice/Text and/or e-mail to secondary caretaker 3

06:00—Voice/Text and/or e-mail to secondary caretaker 3

07:00—Urgent Voice/Text and/or e-mail to secondary caretaker 1

07:30—Urgent Voice/Text and/or e-mail to secondary caretaker 2

08:00—Urgent Voice/Text and/or e-mail to secondary caretaker 3

24:00—Add user record to report

Pursuant to the secondary_caretaker_enrollment function, the potential secondary caretaker will receive from the system implementing the invention an email introducing the service and inviting them to accept the responsibility of secondary caretaker. The email will provide them with GUI links/buttons for them to accept or reject the responsibility. Clicking the acceptance GUI link/button will cause the system implementing the invention to redirect the secondary caretaker to the terms and conditions GUI, which they must accept to continue. If the secondary caretaker accept the terms, they will be presented with a GUI form where they will be able submit data such as a valid phone number and mark their preference for receiving voice, text or e-mail messages. The e-mail message is only available if the e-mail is pushed directly to a secondary caretaker's terminal and is immediately viewable similar to a text. Submitting the GUI form will result in an automated voice/text message requiring the secondary caretaker to confirm that they have received the message. Upon confirmation, registration is complete and the secondary caretaker is active. Clicking the rejection GUI link/button will update the user's secondary caretaker list to show the enrollment denied GUI message, and will preclude that email address from being sent secondary caretaker invitations in the future.

Pursuant to the caretaker_update function, every six months following registration, each secondary caretaker will receive an email which will display their current phone number, choice of either voice or text messages. Each secondary caretaker will be presented with links to confirm that either: (i) the information is correct and they wish to continue using this email address for notifications wherein submitting this option simply sets a date six months in the future for the next email or (ii) they wish to update the information on file, wherein submitting this option redirects them to a GUI form where they can update their name, phone, choice of voice or text, and email data and when the data in the GUI form is submitted, new information is saved and a date six months in the future is set for the next email; or (iii) the secondary caretaker no longer desires to be a secondary caretaker wherein submitting this option redirects them via an are_you_sure function with GUI buttons for confirm and cancel. Submitting confirm deletes the secondary caretaker from a user's secondary caretaker data and an email is sent to the user notifying them of the caretaker's unenrollment and ineligibility for future solicitation. Submitting cancel redirects the secondary caretaker to the GUI form where they can update their information and then the date six months in the future is set for the next email. If the secondary caretaker fails to respond to the email, the system implementing the invention will resend a secondary caretaker update email after one week. If there has still been no response one week after that, the data in the user's secondary caretaker database will be updated to show an e-mail no longer valid message on the line associated with that secondary caretaker.

Pursuant to the failed_payment function, If the user's payment does not process correctly, an email will be sent to the user notifying them that their account is suspended until a payment is made.

Further aspects of the invention include additional functionality to the administrator function including allowing the duration of the trial period to be chosen as a setting; displaying an income calendar so that admins can see a breakdown of the revenue being generated throughout the month; displaying a list of users currently in overdue status; allowing an administrator to specify appropriate discounts during affiliate creation; allowing for an administrator to input amounts paid to affiliates for tracking purposes; optionally save a telephone number to be used for a final voice notification in the event that a user is 24 hours overdue and neither the user nor any of their caretakers has responded to the system; allowing users to choose which day of the month their payments are processed using a prorating fees function.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method performed by a computer system having at least one microprocessor having electronic circuitry directed by a computer program comprising instructions embodied on a non-transitory computer readable medium and at least one memory comprising a non-transitory computer readable medium, for notifying a secondary caretaker of the inability of a primary caretaker to tend to the health or welfare of a designated pet or person, comprising the steps of:
providing a caretaker database table having fields correlating to primary caretaker identification, secondary caretaker identification and designated pet or person identification;
providing at any end station, a graphical user interface (GUI) for creating a specific record in the caretaker database table;
authorizing a user to populate, at any end station via a GUI, the specific record in the caretaker database table with primary caretaker identification data, secondary caretaker identification data and designated pet or person identification data;
setting by a user, a check-in time via a GUI at any end station, the check-in time being received in a time set module correlated to a specific record in the caretaker database table;
checking a primary caretaker check-in value;
if the primary caretaker check-in value is true, prompting a reset of the time set module to a new check-in time or terminate the computer program; and
while the check-in value is false, continue comparing, by the microprocessor, the check-in time against an actual time and when the actual time is equal to or later than the check-in time, accessing the secondary caretaker identification data and sending a message to the secondary caretaker.

2. The method of claim 1, wherein the computer program comprises a client component at an end station local to a user and a server component on a server end station remote to the user, the client component accessing the server component coupled over a computer network comprising a plurality of network elements.

3. The method of claim 2, wherein the client component communicates with the server component over wired media, a wireless media or a combination thereof, using physical, data, link and transport layer protocols.

4. The method of claim 1, wherein the primary caretaker identification data comprises the name of the primary caretaker and billing information of the primary caretaker, the billing information being correlated to banking information of the primary caretaker.

5. The method of claim 1, wherein the designated pet or person identification data comprises the location of the designated pet or person.

6. The method of claim 5, wherein the designated pet or person identification data further comprises a name and care instructions of the designated pet or person.

7. The method of claim 1, wherein the secondary caretaker identification data comprises an identifier at which the message can be sent to the secondary caretaker.

8. The method of claim 7, wherein the identifier consists of one selected from the group consisting of an address, a telephone number, an e-mail address, a media access control (MAC) address, and an Internet Protocol (IP) address.

9. The method of claim 8, wherein the message comprises one selected from the group consisting of a letter, a text message, an automated telephone call, an Internet Message (IM) chat message, a VoIP call and an e-mail.

10. The method of claim 9, wherein the message alerts the secondary caretaker, based on the primary caretaker check-in value being false, that the secondary caretaker should check on the health or welfare of the designated pet or person at the location specified in the designated pet or person data.

11. The method of claim 1, further comprising the step of authorizing a user to access the computer program so as to create a specific caretaker database record and receive data therein only upon the prior transfer of funds from an account of the primary caretaker or a designee thereof to a third party.

12. The method of claim 1, wherein the GUIs comprise a plurality of GUIs coupled across a plurality of web pages or display screens.

13. The method of claim 1, wherein the check-in time comprises a date, comprising a month, day and year, and time, comprising at least hour and minutes and either p.m. or a.m., and a time zone identification.

14. A computer system having at least one microprocessor comprised of electronic circuitry directed by a computer program comprising instructions embodied on a non-transitory computer readable medium and at least one memory comprising a non-transitory computer readable medium, configured to notify a secondary caretaker of the inability of a primary caretaker to tend to the health or welfare of a designated pet or person, comprising:
a caretaker database table with fields correlating to primary caretaker identification, secondary caretaker identification and designated pet or person identification;
an end station having input device operable to allow a user to populate the caretaker database table with primary caretaker identification data, secondary caretaker identification data and designated pet or person identification data;
a time set module configured to receive a check-in time correlated to a specific caretaker database record;
the at least one microprocessor further configured to check if a primary caretaker check-in value is true or false;
if the primary caretaker check-in value is true, the microprocessor configured to prompt a reset of the time set module to a new check-in time or terminate the computer program;
while the primary caretaker check-in value is false, the microprocessor configured to continue to compare the check-in time against the actual time; and
when the actual time is equal to or later than the check-in time, the microprocessor is configured to access the secondary caretaker identification data from the associated record from the caretaker database table and cause a message to be sent to the secondary caretaker.

15. The computer of claim 14, wherein the computer program comprises a client component on an end station local to a user and a server component on a server end station remote to the user, the client component accessing the server component coupled over a computer network having a plurality of network elements.

16. The computer of claim 15, wherein the client component communicates with the server component over wired media, a wireless media or a combination thereof, using physical, data, link and transport layer protocols.

17. The computer of claim 14, wherein the primary caretaker identification data comprises the name of the primary caretaker and billing information of the primary caretaker, the billing information being correlated to banking information of the primary caretaker.

18. The computer of claim 14, wherein the designated pet or person identification data comprises the location of the designated pet or person and care instructions of the designated pet or person.

19. The computer of claim 18, wherein the secondary caretaker identification data comprises an identifier at which the message can be sent to the secondary caretaker.

20. The computer of claim 19, wherein the identifier consists of one selected from the group consisting of a telephone number, e-mail address, media access control (MAC) address, and Internet Protocol (IP) address and the message comprises one selected from the group consisting of a text message, automated telephone call, Internet Message (IM) chat message, VoIP call and e-mail.
